(19) United States
(12) Patent Application Publication
(10) Pub. No.: US 2013/0208909 A1
(43) Pub. Date: Aug. 15, 2013

(54) DYNAMIC HEARING PROTECTION METHOD AND DEVICE

(71) Applicant: Hans Mülder, Wunnewil (CH)

(72) Inventor: Hans Mülder, Wunnewil (CH)

(73) Assignee: PHONAK AG, Staefa (CH)

(21) Appl. No.: 13/823,480

(22) PCT Filed: Sep. 14, 2010
(86) PCT No.: PCT/EP2010/063473

§ 371 Date: Apr. 22, 2013

(51) Int. Cl. G10K 11/16

(52) U.S. Cl. CPC G10K 11/16
USPC 381/71.6

(57) ABSTRACT

A dynamic hearing protection method and device with which a hearing protection device specific differential head related transfer function corresponding to the difference between an open ear resonance measurement of the user's ear canal or an ear canal approximating the user's ear canal without the hearing protection device being worn in the ear canal and an open ear resonance measurement with the hearing protection device being worn in the ear canal as a function of the angle of sound incidence is determined and when using the hearing protection device, a frequency-dependent gain function to the captured audio signals selected according to the presently determined angle of sound incidence with each of the gain functions is determined by inverting the previously determined HPD specific differential HRTF for the respective sound incidence angle, to compensate for the effect of the presence of the hearing protection device on the open ear resonance.

### BACKGROUND OF THE INVENTION

1. Field of the Invention

The invention relates to a method of providing dynamic hearing protection to a user and to a dynamic hearing protection device.

2. Description of Related Art

One type of dynamic hearing protection devices comprise a shell to be worn at least partly in the user's ear canal, a microphone for capturing audio signals from ambient sound, an audio signal processing unit for processing the captured audio signals, and a loudspeaker for stimulating the user's hearing according to the captured audio signals. The shell may have the shape of an ear plug and provides for an attenuation of ambient sound reaching the user's ear. The microphone, the audio signal processing unit and the speaker are provided for providing the hearing protection device (HPD) with a partially or fully transparent mode in which during times of relatively low noise levels useful sound, such as a person speaking to the user of the hearing protection device, can be perceived essentially unattenuated by the user of the hearing protection device despite wearing the hearing protection device. An example of such an active hearing protection device is described in European Patent Application EP 1 674 061 A1.

One problem encountered in hearing protection is that the hearing protection device significantly changes the transfer function of the ear, in particular of the ear canal, whereby in particular sound localization issues are severely affected. In other words, the user's capability of sound localization is compromised by the loss of pinna effects once the shell of a hearing protection device is inserted into the ear. Also, front/back confusions can occur easily, since no left ear/right ear time and level differences are available to the brain. Such loss of localization skills is especially dangerous in applications where ambient awareness and correct localization of sound sources are vital, like in military applications, but also in industry or traffic applications. In cases where visual cues are not available (for example, when the hearing protection device is used during night time) correct localization of sound is even more important.

Another type of dynamic hearing protection devices generates phase-reversed sound or “anti-sound”, i.e. acoustical waves having the phase reversed with respect to the direct ambient sound, in order to at least partially suppress the direct sound at the user's eardrum by destructive interference. Thereby the need for mechanical sound attenuation by the hearing protection device is eliminated or at least reduced. An example of such hearing protection device is described in U.S. Patent Application Publication 2007/0263891 A1 corresponds to U.S. Pat. No. 8,213,653 B2.

European Patent Application EP 1 443 798 A2 relates to a hearing instrument comprising a microphone arrangement which is to be placed behind the ear and which comprises two spaced-apart microphones which are used for achieving frequency-dependent beam forming, wherein the two microphones are operated in an omnidirectional characteristic for frequencies up to 2 kHz whereas they are operated at frequencies above 2 kHz in a beam former configuration having, for example, a first order cardoid transfer characteristic in order to compensate for the loss of pinna directivity effect caused by the arrangement of the microphones behind the pinna.

### SUMMARY OF THE INVENTION

It is an object of the invention to provide for a dynamic hearing protection method and device, wherein sound localization cues are preserved as far as possible.

According to the invention, this object is achieved by a dynamic hearing protection method and a dynamic hearing protection device as described herein.

The invention is beneficial in that, by determining a hearing protection device specific differential head related transfer function (HRTF)—corresponding to the difference between an open ear resonance measurement of the user's ear canal or an ear canal approximating the user's ear canal without the hearing protection device being worn in the ear canal and an open ear resonance measurement with the hearing protection device being worn in the ear canal as a function of the angle of sound incidence—and by applying, when using the hearing protection device, a frequency-dependent gain function to the captured audio signals which is selected according to the presently determined angle of sound incidence (i.e., according to the present main sound incidence direction), with each of the gain functions being determined by inverting the previously determined HPD specific differential HRTF for the respective sound incidence angle, the effect of the presence of the hearing protection device on the open ear resonance can be compensated, thereby preserving a high degree of sound localization capability of the user.

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 is a schematic view of a mechanical configuration of an example of a hearing protection system according to the invention;

FIG. 2 is a block diagram of electronic components of an example of a hearing protection system according to the invention;

FIG. 3 is a schematic top view illustration of a measurement for determining a HPD-specific differential HRTF for a hearing protection system according to the invention.

### DETAILED DESCRIPTION OF THE INVENTION

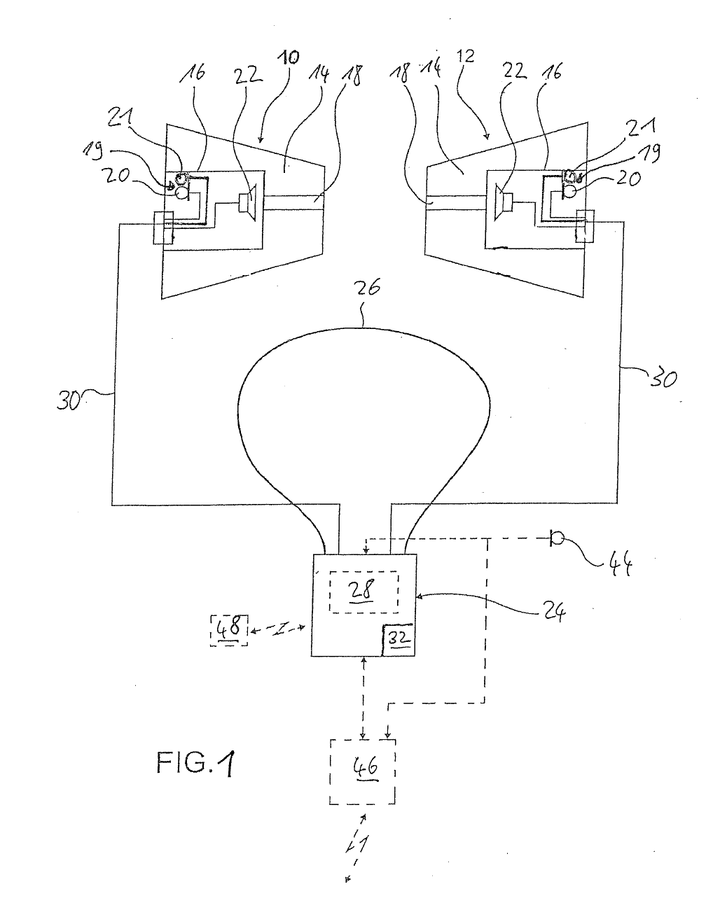

FIG. 1 is a schematic representation of a dynamic hearing protection system for a user comprising a hearing protection earplug 10 which is to be worn at least partly within the user's right ear canal and a hearing protection earplug 12 which is to be worn at least partly within the user's left ear canal.

Each hearing protection earplug 10, 12 comprises a shell 14 which is adapted to be worn at least in part in the user's ear canal, i.e. at least a distal portion of the shell could be inserted into the outer part of the user's ear canal in order to protect the user from excessive levels of ambient sound.

Preferably, the shell 14 is a customized shell, i.e., a hard or soft, but firm, shell having an outer surface individually shaped according to the inner shape of the user's outer ear and ear canal, which may be measured, for example, by direct laser scanning or by forming an impression. The customized shell may be produced by an additive process, such as layer-by-layer sintering of a powder material. Customized earplugs are described, for example, in U.S. Patent Application Publication 2003/0133583 A1 corresponds to U.S. Pat. No. 6,766,878 B2.

Typically, the shell 14 will provide for a (passive) acoustic attenuation of about 25 dB for medium frequencies (the attenuation is higher for higher frequencies, for example, increasing from about 20 dB at low frequencies to about 30 dB for high frequencies).

Each earplug 10, 12 is also provided with an active unit 16 for adjusting the frequency dependency of the attenuation and the degree of attenuation provided by each earplug 10, 12. The active unit 16 typically is inserted into a corresponding receptacle of the shell 14 and is locked there by corresponding locking means (not shown in FIG. 1) in a releasable manner. Thereby the shell 14 can be easily replaced, for example, if damaged.

The shell 14 is provided with a sound channel 18, by which the active unit 16 is acoustically connected to the ear canal. Preferably the shell 14 is designed such that it provides for an acoustic attenuation of at least 10 dB averaged over the audible frequency range when worn by the user.

The active unit 16 comprises a microphone arrangement 19 comprising at least two spaced apart microphones 20 and 21 for capturing audio signals from ambient sound and a loudspeaker 22 for providing audio signals to the user's ear canal via the sound channel 18. Earplugs comprising an active unit are described, for example, in European Patent Application Publication EP 1 674 059 A1.

The system also comprises a central unit 24 which is to be worn at the user's body below the user's neck, for example, by a loop 26 around the user's neck, and which comprises an audio signal processing unit 28 for receiving and processing the audio signals captured by the microphones 20, 21 in order to supply the loudspeakers 22 with audio signals to be reproduced to the user's ear. To this end, the active units 16 are connected to the central unit 14 via cable connections 30 or wirelessly, such as via a short range full audio radio link (not shown). The central unit 24 may be provided with a user interface 32 comprising, for example, a button or a wheel for enabling the user to manually control the function of the audio signal processing unit 28. The skilled person will understand that the central unit 24 includes the necessary analog-to-digital and digital-to-analog converters and a battery (which are not shown). Sampling rates must be high enough to preserve also the high audible frequencies in the signal.

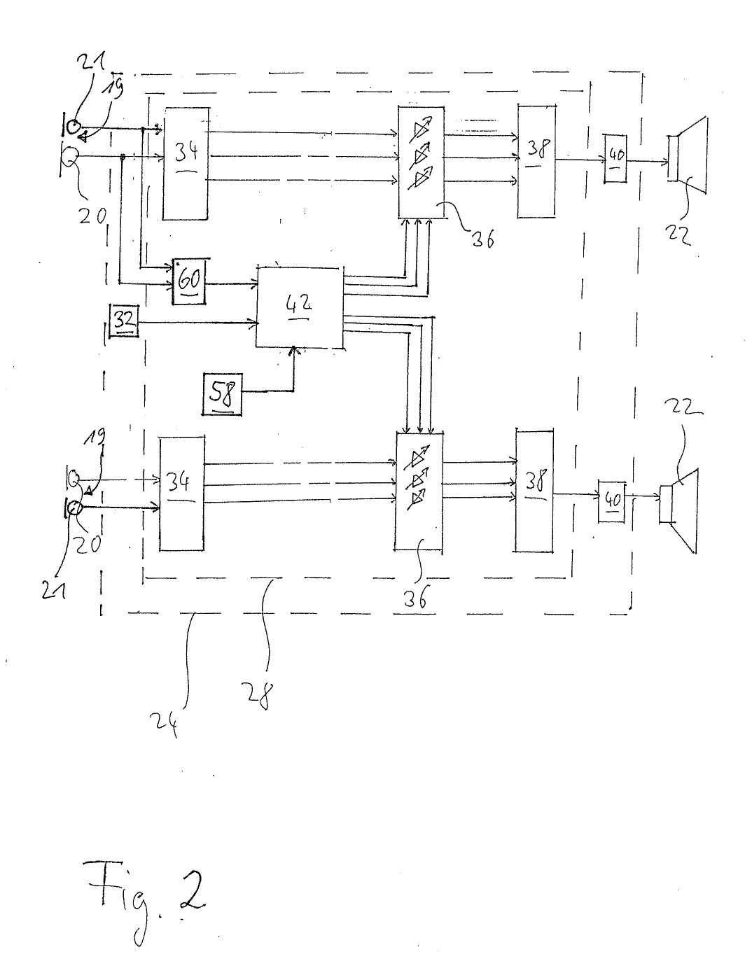

For each of the active units 16, the audio signal processing unit 28 comprises a unit 34 (see FIG. 2) for dividing the input audio signals provided by the microphone 20 into a plurality of frequency bands, a unit 36 for selective amplification of each of the frequency bands, i.e., a multi-channel variable gain amplifier, and a unit 38 for generating a single time domain filtered audio signal from the frequency channels, which filtered audio signal is supplied to an output driver 40 which drives the loudspeaker 22. The frequency divided input audio signals are also supplied to a control unit 42 which is designed to select the gain applied within each frequency band in the amplifier unit 36 according to a “HPD-specific differential HRTF”, as will be explained later in detail.

The HRTF describes how a given sound wave input (parameterized as frequency and source location) is filtered by the diffraction and reflection properties of the head, pinna and torso before the sound reaches the ear drum. The source location specific pre-filtering effects of these external structures aid in the neural determination of source location. The physical presence of hearing protection devices, such as the earplugs 10, 12, significantly changes the natural HRTF of the user, thereby deteriorating sound source localization capability of the user. According to the present invention, such detrimental effect of the presence of the HPD is compensated as far as possible by determining a “HPD specific differential HRTF” which includes the loss of open ear canal resonance but contains also angle dependent information, namely the subtle filtering at specific frequencies which vary with the angle of sound incidence. According to the invention, such knowledge of the HPD specific differential HRTF is used for restoring the open ear resonance by inverting that HPD specific differential HRTF for each sound incidence angle and selecting the frequency-dependent gain function applied to the captured audio signals according to the presently prevailing sound incidence angle.

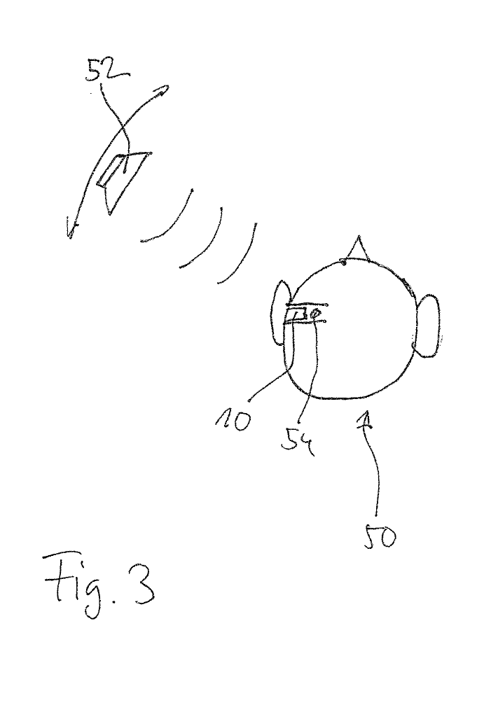

The HPD specific differential HRTF can be determined, for example, by a setup as schematically shown in FIG. 3, wherein the open ear resonance of a dummy head 50 is measured as a function of the angle of sound incidence in the horizontal plane, for example in steps of 10 degrees, with a sound source 52 and the dummy head 50 being rotated relative to each other accordingly (the sound source 52 may be moved around the dummy head 50, or the dummy head 50 may be rotated around itself). During such measurement, a microphone 54 located in an ear canal 56 at a position close to the eardrum measures the sound pressure level as function of the sound incidence angle and of the sound frequency, with the ear canal 56 being open, i.e., with no hearing protection device being placed in the ear canal. Thereby the open ear resonance of the dummy head 50 is measured.

The measurement then is repeated with a hearing protection ear plug 10 having been inserted into the ear canal 56. The HPD specific differential HRTF is determined by forming the difference between the measurement without the hearing protection device 10 being worn in the ear canal 56 and the measurement with the hearing protection device 10 being worn in the ear canal 56. The HPD specific differential HRTF can be inverted for each sound incidence angle and can be used by the control unit 42 to select the gain applied within the amplifier unit 36 in a manner so as to restore the open ear resonance, i.e., to compensate for the effect of the presence of the ear plugs 10, 12 in the ear canal of the user. To this end, data corresponding to the HPD specific differential HRTF may be stored in a memory 58 of the hearing protection system, which data is accessible by the control unit 42.

The hearing protection system also comprises a unit 60 which determines or estimates the presently prevailing sound incidence angle from the audio signals captured by the microphones 20, 21. To this end, the microphones 20, 21 (or the respective microphone ports) are arranged in such a manner that they are located in a substantially horizontal plane when the earplugs 10, 12 are worn by the user; the sound incidence angle can be determined from the relative delay between the audio signals provided by the microphone 20 and the microphone 21. The determined sound incidence angle is dominated by the direction of the source of that sound event which has the highest sound pressure level. The presently prevailing sound incidence angle is supplied from the angle determination unit 60 to the control unit 42 which, based on the inverted HPD specific differential HRTF data retrieved or calculated from the data stored in the memory 58, selects the gain function to be presently applied to the audio signals by the amplifier unit 36 according to the presently prevailing sound incidence angle.

Although HRTFs are person-specific due to the specific size and shape of the head and the ear, in most cases satisfactory restoring of the open ear resonance will be obtained by determining the HPD specific differential HRTF from dummy head measurements. Rather than using a dummy head, such measurements, of course, also could be carried out on the head of a test person. However, if a particularly accurate restoring of the open ear resonance is desired, the measurements may be carried out on the head of the individual person who wants to use the hearing protection system in order to determine the individual HPD specific differential HRTF.

According to one embodiment of the invention, in order to optimize the restoring of the open ear canal resonance, the present use situation of the hearing protection system may be taken into account. Such use situations may be characterized by whether the user wears a certain type of head gear (typically a protective head gear, such as a helmet or a gas mask), or whether he wears no head gear at all. In this case, for each of the use situations a separate measurement of the HPD specific differential HRTF is carried out, with the dummy head (or the test person or the individual user) wearing during the measurements the respective type of protective head gear by which the respective use situation is characterized. In other words, the above-described open ear resonance measurements with and without the hearing protection ear plug 10, 12 being inserted in the ear canal 56, are carried out also for situations in which a certain type of head gear is worn, i.e., the dummy head (or test person, etc.) wears the same type of head gear which will be worn by the user later.

Thus, for each use situation a special HPD specific differential HRTF is determined which is attributed to the respective use situation. The presently prevailing use situation during the actual use of the hearing protection system may be entered into the control unit 42 via the user interface 32, and the control unit 42 then will apply the respective HPD specific differential HRTF according to the data stored in the memory 58.

Of course, if the hearing protection system is used always with a certain type of head gear, then it is not necessary to determine the HPD specific differential HRTF without protective head gear.

In general, restoring of the open ear resonance may not only improve localization in the horizontal plane but may also contribute to an enhanced sensation of space in three dimensions, which may lead to improved feeling of safety. An improved localization may also lead to other improvements when it comes to localization, which includes sensing distances and sensing movements, speed and direction of a moving sound source. The improved localization and enhanced feeling of safety may contribute to better compliance with the hearing protection system, which is a key factor to the overall safety and effectiveness of a hearing protection program.

In addition to the components discussed so far, the hearing protection system could be provided with a communication function, wherein at least one additional microphone would be provided for capturing the user's voice. Such additional microphone may be a boom microphone attached to one of the earplugs (as indicated in FIG. 1 at 44 in dashed lines). An example of a system comprising a boom microphone is described in International Patent Application Publication WO 2007/082579 A2 and corresponding U.S. Patent Application Publication US 2010/0119077. In such case, the audio signal processing unit would be connected to a communication device, for example, an FM transceiver (as indicated in FIG. 1 at 46), in order to send the audio signals corresponding to the captured voice of the user to another person or to receive audio signals to be presented via the loudspeakers 22 from an external source, such as another person.

According to an alternative embodiment, the user interface 32 may be implemented as a remote control (indicated in FIG. 1 at 48) rather than being provided as part of the central unit 24.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

1-12. (canceled)

13. A method of providing dynamic hearing protection to a user, comprising:
measuring an open ear resonance of an ear canal of the user or an ear canal approximating the user' ear canal, without a hearing protection device being worn in the ear canal, as a function of an angle of sound incidence;
measuring an open ear resonance of the ear canal of the user or an ear canal approximating the user' ear canal, with a hearing protection device being worn in the ear canal, as a function of an angle of sound incidence;
forming a difference between a measurement without the hearing protection device being worn in the ear canal and a measurement with the hearing protection device being worn in the ear canal in order to determine a hearing protection device specific differential head related transfer function;
inserting the hearing protection device into the user's ear canal;
capturing audio signals from ambient sound emitted by a sound source by a microphone arrangement of the hearing protection device;
determining an angle of incidence of the ambient sound emitted by the sound source;
processing the captured audio signals by applying a frequency dependent gain function selected according to the determined angle of ambient sound incidence from a plurality of gain functions to the captured audio signals, wherein each of the gain functions is determined by inverting said hearing protection device specific differential head related transfer function for a respective angle of sound incidence, in order to compensate for an effect of a presence of the hearing protection device on the open ear resonance;
stimulating a user's hearing via the hearing protection device according to the processed audio signals.

14. The method of claim 13, wherein the angle of sound incidence is defined in a substantially horizontal plane.

15. The method of claim 14, wherein the microphone arrangement comprises at least two spaced apart microphones, and wherein the angle of incidence of the ambient sound emitted by the sound source is determined from the captured audio signals.

16. The method of claim 15, wherein the at least two spaced apart microphones are located in a substantially horizontal plane.

17. The method of claim 13, wherein the open ear resonance measurements are carried out on an artificial ear canal of a dummy head.

18. The method of claim 13, wherein the open ear resonance measurements are repeated for a plurality of use situations of the hearing protection device in order to determine a plurality of hearing protection device differential specific head related transfer functions, wherein each hearing protection device specific differential head related transfer function is attributed to a different one of the use situations, and wherein in the audio signal processing that one of the hearing protection device specific differential head related transfer functions is used which corresponds to a present use situation of the hearing protection device.

19. The method of claim 18, wherein each use situation is characterized by the user of the hearing protection device wearing a certain type of headgear or no headgear at all, and wherein the open ear resonance measurements are carried out with a person or an object whose ear canal is measured wearing said certain type of headgear or no headgear at all, respectively.

20. The method of claim 19, wherein the headgear includes helmets and gas masks.

21. The method of claim 13, wherein the hearing protection device provides for a sound attenuation of at least 10 dB.

22. A dynamic hearing protection device comprising:
a shell to be worn at least partly in a user's ear canal,
at least two spaced apart microphones for capturing audio signals from ambient sound,
an audio signal processing unit for processing the captured audio signals, and
means for stimulating a user's hearing according to the processed audio signals,
wherein the audio signals processing unit comprises means for determining a present angle of incidence of sound from a sound source,
wherein the audio signals processing unit comprises means for processing the audio signals in a manner so as to apply a frequency dependent gain function selected from a plurality of gain functions according to a presently determined angle of sound incidence to the audio signals,
wherein each of the gain functions is to be determined by inverting a hearing protection device specific differential head related transfer function for a respective angle of sound incidence, in order to compensate for an effect of a presence of the hearing protection device on an open ear resonance, said hearing protection device specific differential head related transfer function being determined from a difference of a first measurement of an open ear resonance of the ear canal of the user or an ear canal approximating the user' ear canal, without the hearing protection device being worn in the ear canal, as a function of an angle of sound incidence and a second measurement of an open ear resonance, with the hearing protection device being worn in the ear canal.

23. The device of claim 22, wherein the shell is shaped as an earplug.

24. The device of claim 22, wherein the microphones are located at a proximal end of the shell in order to be located within a pinna of the user's ear.
